(19) United States
(12) Patent Application Publication
(10) Pub. No.: US 2017/0040099 A1
(43) Pub. Date: Feb. 9, 2017

(54) ELECTROMAGNETIC APPARATUS AND METHOD FOR PROVIDING THE SAME

(71) Applicant: General Electric Company, Schenectady, NY (US)

(72) Inventors: Ravindra Shyam BHIDE, Rugby (GB); Ajith Kuttannair KUMAR, Erie, PA (US); Srilatha BOYANAPALLY, Bangalore (IN); Manoj Ramprasad SHAH, Latham, NY (US)

(21) Appl. No.: 15/126,603

(22) PCT Filed: Mar. 21, 2014
(86) PCT No.: PCT/US2014/031466

§ 371 Date: Sep. 16, 2016

(51) Int. Cl. H01F 27/25; H01F 41/06; H01F 41/02; H01F 27/26

(52) U.S. Cl. CPC H01F 27/25; H01F 27/263; H01F 41/06; H01F 41/0206

(57) ABSTRACT

An electromagnetic apparatus including a static electromagnetic device is provided. The static electromagnetic device includes a yoke and at least three limbs comprising windings for forming a magnetic core of the static electromagnetic device wherein an angle between the at least three limbs is equal and at least one of the at least three limbs or the yoke comprises a duct.

### BACKGROUND

Embodiments of the invention generally relate to an electromagnetic apparatus and more particularly to static electromagnetic devices comprising magnetic cores and the method for providing the same.

Nowadays, electromagnetic devices are used for various purposes. Based on their operating principle, the electromagnetic devices may be classified into electromagnetic rotating devices such as electric motors, electromagnetic linear machines/actuators and static electromagnetic devices such as transformers and reactors.

During operation, core losses among other losses in the static electromagnetic devices generate heat. The core losses reduce a life span of the static electromagnetic device and lead to increased maintenance costs. In the past, different approaches have been used to reduce the heat in the static electromagnetic devices. One such approach is to provide an air cooled static electromagnetic device which reduces the heat in the static electromagnetic device using air. However, there is scope for further reducing the heat and the core losses in the static electromagnetic devices.

Hence, there is a need for an improved system to address the aforementioned issues.

### BRIEF DESCRIPTION

Briefly, in accordance with one embodiment, an electromagnetic apparatus including a static electromagnetic device is provided. The static electromagnetic device includes a yoke and at least three limbs comprising windings wound on a magnetic core of the static electromagnetic device wherein an angle between the at least three limbs is equal and at least one of the at least three limbs or the yoke comprises a duct.

In another embodiment, a method for providing a static electromagnetic device is provided. The method includes forming at least three limbs of a magnetic core of a static electromagnetic device such that an angle between the at least three limbs is equal. The method also includes providing magnetic windings around the at least three limbs. The method further includes forming a yoke of the magnetic core of the static electromagnetic device. The method also includes providing a duct in at least one of the at least three limbs or the yoke for cooling the static electromagnetic device.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic representation of a static electromagnetic device including three limbs and a yoke wherein the three limbs comprise a duct in accordance with an embodiment of the invention.

FIG. 2 is a schematic representation of three limbs each including one step comprising the plurality of laminates coupled through the overlap mitered joint in accordance with an embodiment of the invention.

FIG. 3 is a schematic representation of a transition between two steps forming the three limbs wherein the first step comprises laminates of width W1 and a first layer of the second step comprising laminates of width W2 disposed above the first step keeping the first limb as base in accordance with an embodiment of the invention.

FIG. 4 is a representation of a transition between two steps forming the yoke wherein the first step comprises laminates of width Y1 and a first layer of a second step comprises laminates of width Y2 disposed above the first step keeping the first limb as base in accordance with an embodiment of the invention.

FIG. 5 is a schematic representation of one embodiment of the limb of FIG. 1 comprising a hexahedron structure in accordance with an embodiment of the invention.

FIG. 6 is a schematic representation of a process of fabrication of the plurality of laminates in accordance with an embodiment of the invention.

FIG. 7 is a schematic representation of an alternative embodiment of the limb including a cruciform shape in accordance with an embodiment of the invention.

FIG. 8 is a schematic representation of the static electromagnetic device of FIG. 1 including the windings wound on the limbs in accordance with an embodiment of the invention.

FIG. 9 is a schematic representation of a static electromagnetic device including rectangular windings wound around six limbs wherein the six limbs are coupled between two concentric yokes in accordance with an embodiment of the invention.

FIG. 10 is a schematic representation of an alternative embodiment of a static electromagnetic device comprising three tape wound cores forming the three limbs in accordance with an embodiment of the invention.

FIG. 11 is a schematic representation of a process depicting compression of a tape wound core to form a desired shape in accordance with an embodiment of the invention.

FIG. 12 is a schematic representation of a static electromagnetic device comprising three gaps in the yoke of the static electromagnetic device in accordance with an embodiment of the invention.

FIG. 13 is a schematic representation of an alternative embodiment of the static electromagnetic device of FIG. 12 comprising three gaps between the at least three limbs and the yoke in accordance with an embodiment of the invention.

FIG. 14 is a schematic representation of another embodiment of the static electromagnetic device of FIG. 1 including insulation material in accordance with an embodiment of the invention.

FIG. 15 is flow chart representing the steps involved in a method for providing a static electromagnetic device in accordance with an embodiment of the invention.

### DETAILED DESCRIPTION

Embodiments of the present invention include an electromagnetic apparatus including a static electromagnetic device. The static electromagnetic device includes a yoke and at least three limbs comprising windings wound on a magnetic core of the static electromagnetic device wherein an angle between the at least three limbs is equal and at least one of the at least three limbs or the yoke comprises a duct.

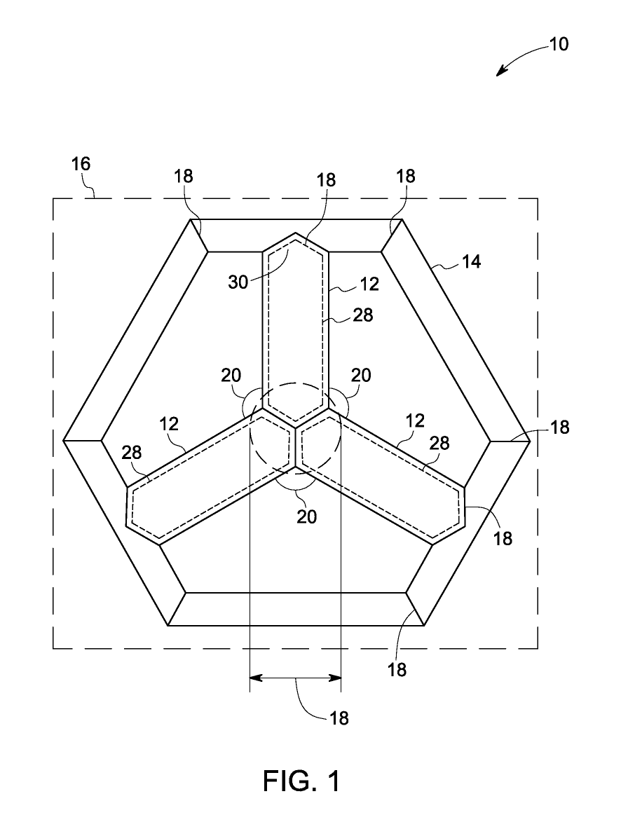

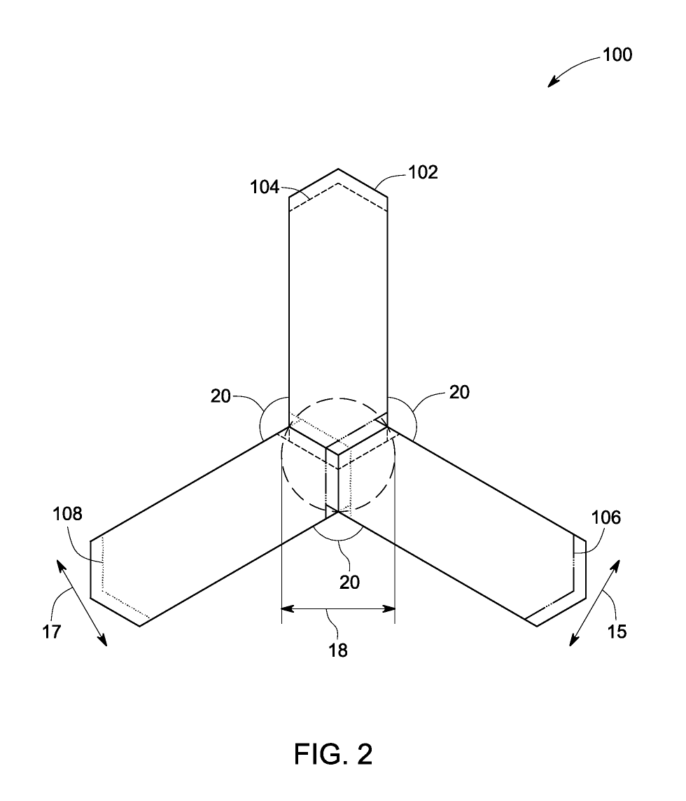

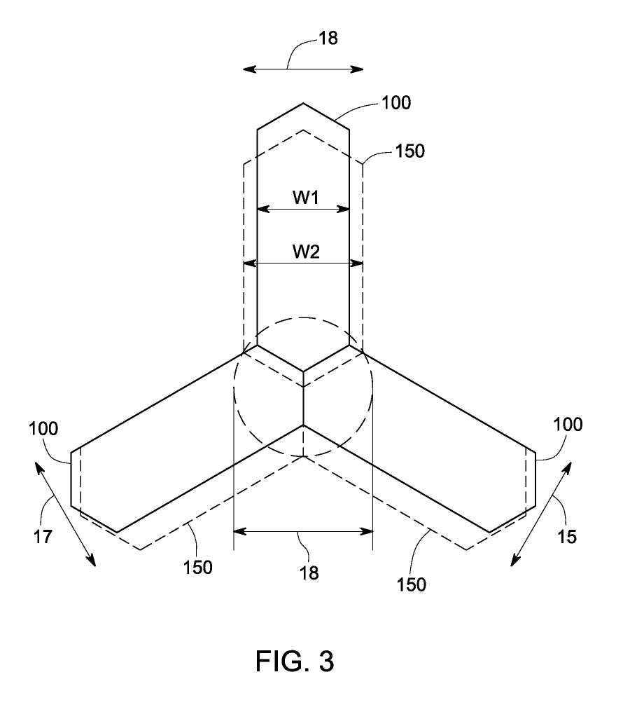

FIG. 1 is a schematic representation of a static electromagnetic device 10 including three limbs 12 and a yoke 14 in accordance with an embodiment of the invention. The three limbs 12 and the yoke 14 form a magnetic core 16 of the static electromagnetic device 10 in which the three limbs 12 and the yoke 14 are coupled to each other through an overlap mitered joint 18 as described in FIG. 2 and FIG. 3 below. As used herein “overlap mitered joint” is defined as a joint of any multi-layered laminations such that a joining edge of one layer should not coincide with a joining edge of any other layer. Each of the three limbs 12 are formed of plurality of laminates disposed in an overlapping manner to form steps (FIG. 2) which form the limb 12. The plurality of laminates may be disposed in several ways in different steps to form the limb 12 of different structures from which some of the structures are discussed below.

FIG. 2 is a schematic representation of three limbs 13, 15, 17 each including one step 100 comprising the plurality of laminates coupled through the overlap mitered joint 18 in accordance with an embodiment of the invention. Assuming that the step 100 includes four laminates of equal width and each of the three limbs 13, 15, 17 comprise only one step 100 each, then the magnetic core will have four layers 102, 104, 106, 108 of laminates disposed one above the other wherein each layer includes three laminates coupled together such that the angle 20 between each of the laminates is equal. A first or a base layer 102 represented by solid lines (—) is formed by joining three laminates to each other such that the angle 20 between each of the laminates is equal. Subsequently, keeping first limb 13 as the base, a second layer 104 of laminates represented by dashed lines (---------) is disposed over the first layer 102 in such a way that the joining edge of the second layer 104 does not coincide with the joining edge of the first layer 102. Notably, since the laminates are of equal sizes and only the laminate at the respective base limb in each layer is offset to provide an overlap mitered joint 18, the remaining two laminates of the remaining two limbs other than the base limb for each layer overlap exactly above the previous layer and are therefore, not clearly visible in the figure. Further, keeping the second limb 15 as base, a third layer 106 represented by dash and dots ( [symbol] ) is disposed on the second layer 104 such that the joining edge of the third layer 106 does not coincide with the joining edge of the second layer 104 and similarly, a fourth layer 108 represented by dots ( [symbol] ) is disposed on the third layer 106 by keeping the third limb 17 as base. Similarly, multiple steps can be formed to form the limbs wherein each step may include laminates of different widths. The yoke (FIG. 1) of the magnetic core (FIG. 1) can also be formed using the overlap mitered joint 18 with laminates corresponding to the shape of the yoke as discussed for the three limbs.

FIG. 3 is a schematic representation of a transition between two steps 100 and 150 forming the three limbs 13, 15, 17 wherein the first step 100 comprises laminates of width W1 and a first layer of the second step 150 comprising laminates of width W2 disposed above the first step 100 keeping the first limb 13 as base in accordance with an embodiment of the invention.

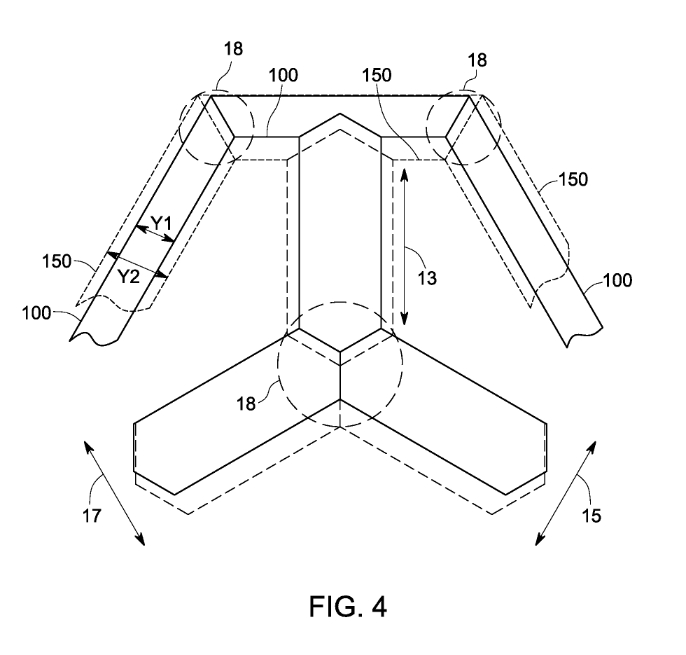

FIG. 4 is a representation of a transition between two steps 100 and 150 forming the yoke 14 wherein the first step 100 comprises laminates of width Y1 and a first layer of a second step 150 comprises laminates of width Y2 disposed above the first step 100 keeping the first limb 13 as base in accordance with an embodiment of the invention.

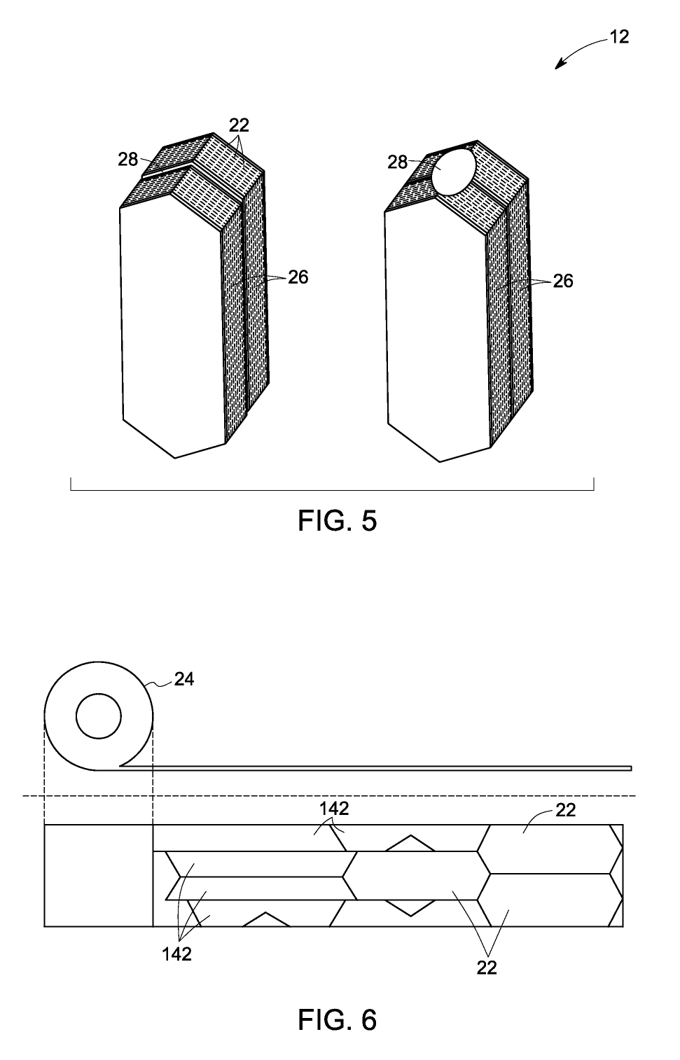

FIG. 5 is a schematic representation of the limb 12 comprising a hexahedron structure in accordance with an embodiment of the invention. In one embodiment, the limbs 12 include the hexahedron structure which provides the angled edges required to form the overlap mitered joint (FIG. 1). In order to form the hexahedron limb 12, the plurality of laminates 22 is first fabricated using the process as shown in FIG. 6.

FIG. 6 is a schematic representation of the process of fabrication of the plurality of laminates 22 for forming the hexahedron limb 12 and the plurality of laminates 142 for forming the yoke 14 in accordance with an embodiment of the invention. In the present process, a cold rolled grain oriented silicon steel (CRGO) bundle 24 is used to fabricate the plurality of laminates 22. A punch and dye method is used to cut the laminates of a desired shape from the CRGO 24. The shape of the laminates is dependent on the shape of the limb 12 which in this case is a hexahedron and therefore, laminates of hexagonal shape 22 are fabricated using the said process to form the hexahedron limb 12.

Referring back to FIG. 5, the plurality of hexagonal laminates 22 (FIG. 6) are disposed on each other in the overlapping manner to form the hexahedron limb 12. In some embodiments, the hexagonal laminates 22 may be disposed in steps 26 to form the hexahedron limb 12 wherein each step 26 includes a set of hexagonal laminates 22 with equal sizes. In a specific embodiment, each step 26 may include “N” number of hexagonal laminates 22 of equal sizes and each limb 12 may include “M” number of steps 26 with different step widths.

In one embodiment, the hexahedron limb 12 includes a duct 28 along the length of the hexahedron limb 12 through which a coolant (not shown) can flow in the static electromagnetic device 10 to reduce heat in the static electromagnetic device 10 and maintain a temperature limit. In one embodiment, the duct 28 may be created while forming the hexahedron limb 12 by providing a space between any two steps 26 of the plurality of laminates 22 while the steps 12 are being disposed in the overlapping manner. In a specific embodiment, the duct 28 comprises a cylindrical shape or a hexahedron shape.

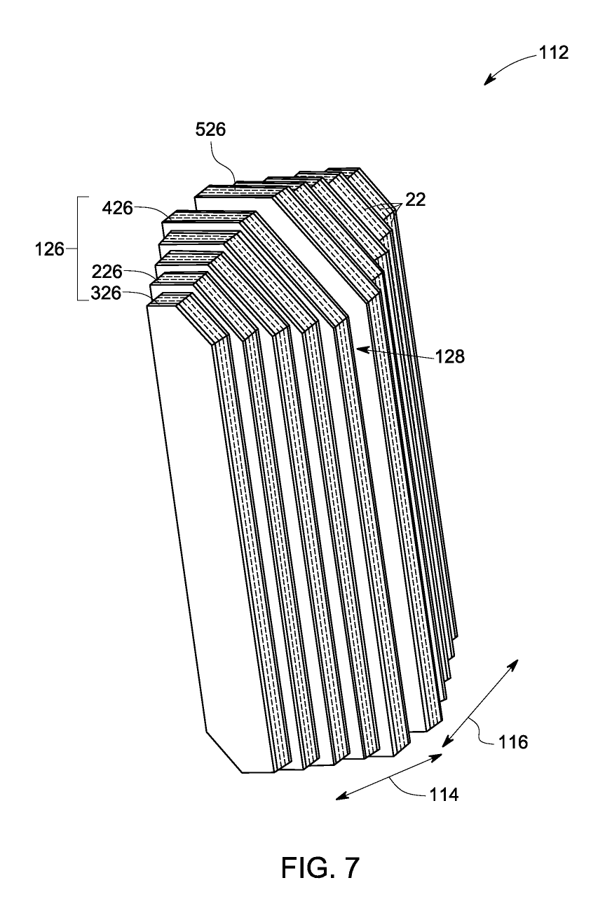

FIG. 7 is a schematic representation of an alternative embodiment of the limb 112 including a cruciform shape in accordance with an embodiment of the invention. To form the cruciform limb 112, a desired height (h) of the cruciform limb 112 is divided into two equal halves comprising a first half 114 and a second half 116 and each of the first half 114 and the second half 116 includes the same number of steps 126. If the cruciform limb 112 comprises “N_{c}” number of steps, then each of the first half 114 and the second half 116 will include “Nc/2” number of steps 126. Each of the steps 126 of the first half 114 is formed by using “Mc” number of hexagonal laminates 22 wherein each of the hexagonal laminates 22 in a particular step 126 has the same width. Furthermore, the steps 126 of the first half 114 are formed in such a way that the width of a subsequent step 226 is greater than the width of a previous step 326 which in turn means that the width of the hexagonal laminates 22 of the subsequent step 226 is greater than the width of the hexagonal laminates 22 of the previous step 326. Therefore, based on the aforementioned conditions, the plurality of hexagonal laminates 22 are fabricated using the above mentioned process of punch and dye and the plurality of hexagonal laminates 22 are disposed in an overlapping manner to form each step 126 of the first half 114 of the cruciform limb 112. Similarly, the second half 116 of the cruciform limbs 112 is formed which is a replica of the first half 114. The second half 116 is coupled to the first half 114 of the cruciform limb 112 such that the steps 426, 526 including the greatest width in the first half 114 and the second half 116 respectively are adjacent to each other to form the cruciform limb 112.

In one embodiment, the cruciform limb 112 includes the duct 128 along the length of the cruciform limb 112 through which a coolant (not shown) can flow in the static electromagnetic device (FIG. 1) to reduce heat in the static electromagnetic device and maintain a temperature limit. In one embodiment, the duct 128 may be created while forming the cruciform limb 112 by providing a space between any two steps 126 of the plurality of laminates (FIG. 6) during disposing the steps 126 in the overlapping manner. In a specific embodiment, the duct 128 is provided by providing the space between the first half 114 and the second half 116. In a more specific embodiment, the duct 128 comprises a cylindrical shape or a hexahedron shape.

Referring back to FIG. 1, the three limbs 12 are coupled to each other to form the overlap mitered joint 18. In this particular embodiment, the at least three limbs 12 include exactly three limbs and the overlap mitered joint 18 forms three angles 20 between each pair of adjacent limbs 12. Each of the three corners 20 formed by the overlap mitered joint 18 have an angle of approximately one hundred and twenty degrees (120°). In other embodiments including “L” number of limbs 12, each of the corner 20 formed by the overlap mitered joint 18 will include the angle of approximately 360/L.

Furthermore, the limbs 12 are enclosed by providing the yoke 14 around the limbs 12 and the three limbs 12 are coupled to the yoke 12 at respective first limb ends 30 wherein a distance between the first limbs ends 30 of any two adjacent limbs 12 is equal. The yoke 14 comprises a shape which is suitable to enclose the limbs 12 and is based on the number of limbs (L) and the structure of the limbs 12. In a particular embodiment, wherein the static electromagnetic device 10 includes the three hexahedron limbs 12, the yoke 14 may be formed of a hexagonal prism shape wherein all faces of the yoke 14 comprise the same dimensions. In another embodiment, the yoke 14 may include a polyhedron shape or a concentric cylindrical shape. The yoke 14 includes a plurality of laminates 142 (FIG. 6) arranged in an over lapping manner to form the faces of the yoke 14. In some embodiments, the plurality of laminates 142 may be arranged in different overlapping manners to form the faces of the yoke 12. In one embodiment, the plurality of laminates 142 for forming the yoke 14 comprise a tetragon shape which are fabricated by the punch and dye method described above. Each face of the yoke 14 is joined together using the overlap mitered joint to form the yoke 14 which encloses the three limbs 12. In one embodiment, the faces of the yoke 14 may be joined using the overlap mitered joint 18.

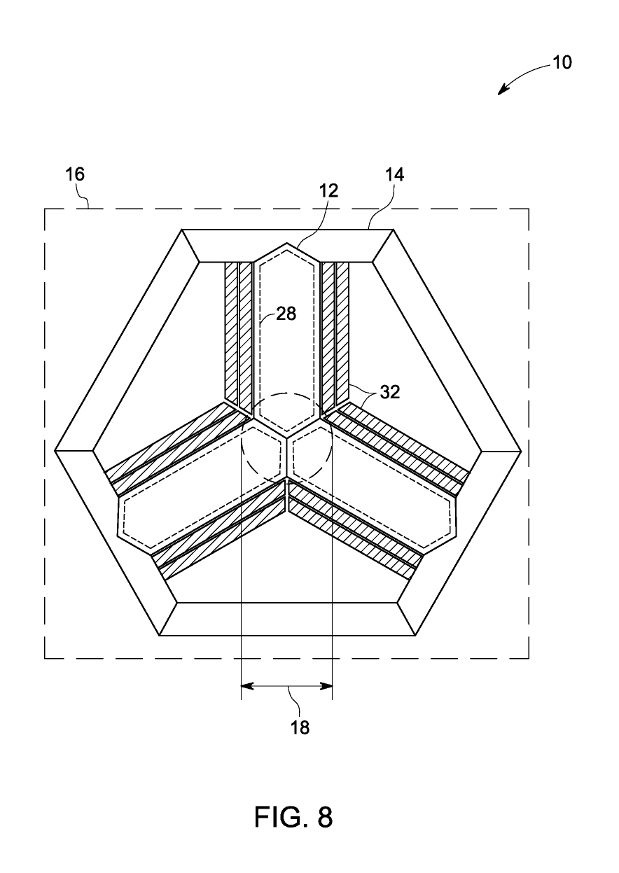

Furthermore, at least one of the limbs 12 or the yoke 14 includes the duct 28 through which the coolant can flow in the static electromagnetic device 10. In one embodiment, the duct 28 may be created during formation of the respective limb 12 comprising the duct 28. In a more specific embodiment, the duct 28 may include a concentric cylindrical shape or a polyhedron shape. In a particular embodiment, the coolant may include oil. Therefore, the yoke 14 and the three limbs 12 form the static electromagnetic device 10 wherein the three limbs 12 include windings as discussed in FIG. 8 below.

FIG. 8 is a schematic representation of the static electromagnetic device 10 of FIG. 1 including the windings 32 in accordance with an embodiment of the invention. The windings 32 are wound around the three limbs 12 and generate a magnetic flux when current passes through the windings 32 during operation. In one embodiment, the windings 32 may include a rectangular winding or tapered winding.

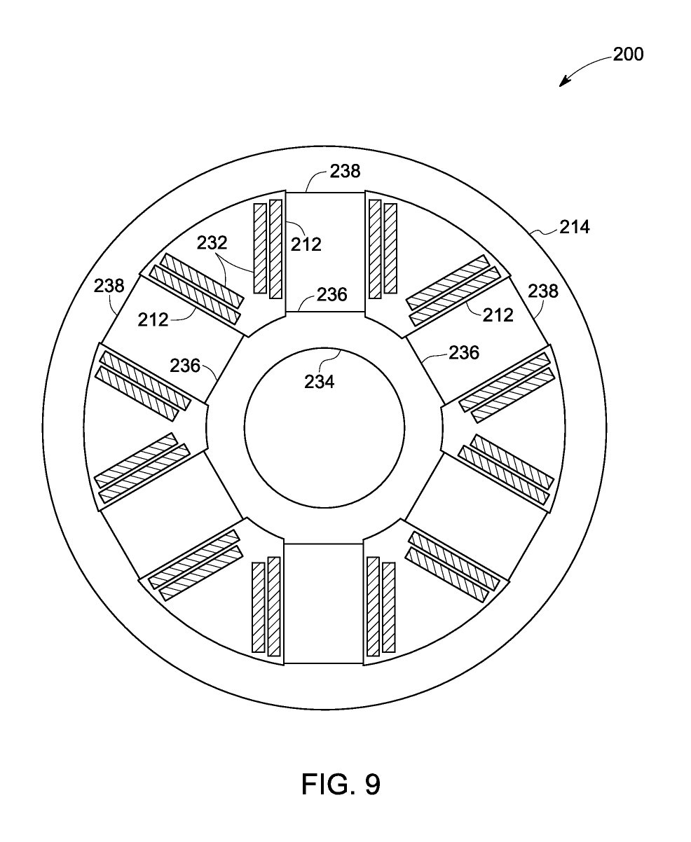

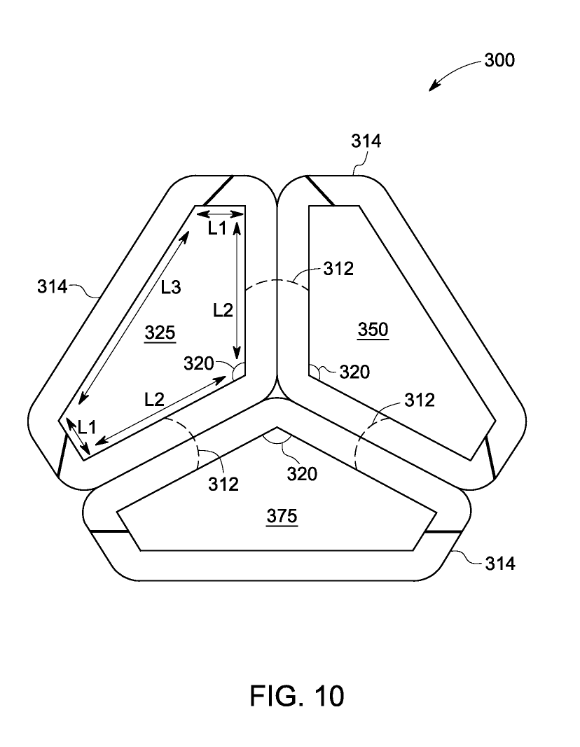

FIG. 9 is a schematic representation of a static electromagnetic device 200 including rectangular windings 232 wound around six limbs 212 coupled to an inner concentric cylindrical structure 234 at first limb ends 236 and to the concentric cylindrical yoke 214 at second limb ends 238 in accordance with an embodiment of the invention. Hereinafter, the term “inner concentric cylindrical structure 234” is referred to as an inner yoke 234 and the term “concentric cylindrical yoke 214” is referred to as an outer yoke 214. The inner yoke 234 comprises a plurality of laminates (FIG. 6) arranged in the overlapping manner to form the inner yoke 234. The plurality of laminates are fabricated using the punch and dye method as discussed above in FIG. 6 and may include the laminates of any shape and size based on the radius of the inner yoke 234. The inner yoke 234 is coupled to the six limbs 212 at the first limb ends 236 wherein the six limbs 212 are formed from the plurality of laminates as discussed above. The six limbs 212 are coupled to the inner yoke 234 such that a distance between the first limb ends 236 of any two adjacent limbs is equal. Furthermore, the six limbs 212 are coupled to the outer yoke 214 at the respective second limb ends 238 of the six limbs 212. Each of the six limbs 212 comprises a rectangular winding 232 wound around the respective limb 212 to generate the magnetic flux in the static electromagnetic device 200.

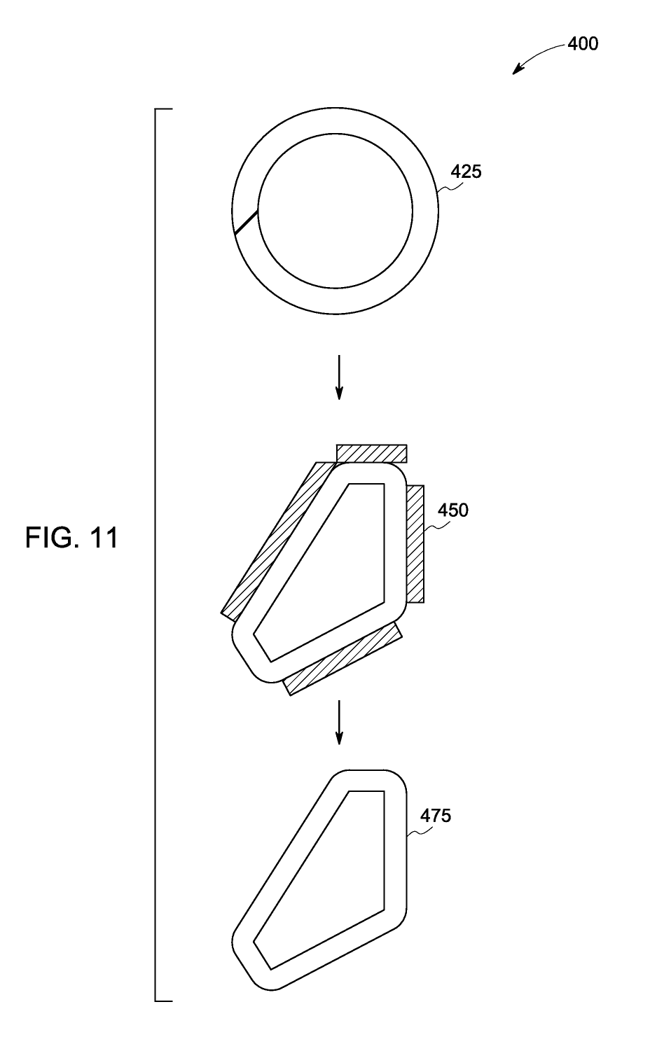

FIG. 10 is a schematic representation of an alternative embodiment of a static electromagnetic device 300 comprising three tape wound cores 325, 350, 375 forming the three limbs 312 in accordance with an embodiment of the invention. The tape wound cores are compressed to form a desired shape to form the limbs and the number of tape wound core to be used is based on the number of limbs required in the static electromagnetic device 300. In this particular embodiment, three tape wound cores 325, 350, 375 are compressed to form a pentahedron shape such that coupling the three tape wound cores 325, 350, 375 together form the three limbs 312 of the static electromagnetic device 300. The process of compressing the tape wound cores 325, 350, 375 for forming the desired shape is discussed below in FIG. 11.

FIG. 11 is a schematic representation of a process 400 depicting compression of a tape wound core 425 to form a desired shape in accordance with an embodiment of the invention. In the first step, a suitable tape wound core 425 is chosen for forming the static electromagnetic device (FIG. 10). The tape wound cores 425 are cores comprising a length of ferromagnetic material in tape form, wound in such a way that each turn falls directly over the preceding turn. The tape wound cores 425 are made from thin strips of high permeability nickel-iron alloys or grain oriented silicon iron and are used for a wide range of frequency applications. In the second step 450, the tape wound cores 425 are compressed using hydraulic or pneumatic compression techniques to form a desired shape 475 required to form the limbs (FIG. 10) of the static electromagnetic device. In one embodiment, the desired shape comprises the pentahedron.

Referring back to FIG. 10, three pentahedron tape wound cores 325, 350, 375 are obtained using the above mentioned process which include two faces comprising a length “L1”, two faces comprising a length “L2” and one face comprising a length “L3” wherein L1<L2<L3. The three tape wound cores 325, 350, 375 are coupled together such that the two faces comprising length L2 of each of the tape wound core 325, 350, 375 are positioned adjacent to each other and form the three limbs 312 such that the angles 320 formed between the two adjacent limbs are equal. The two faces comprising length L1 and one face comprising length L3 form the yoke 314 of the static electromagnetic device 300.

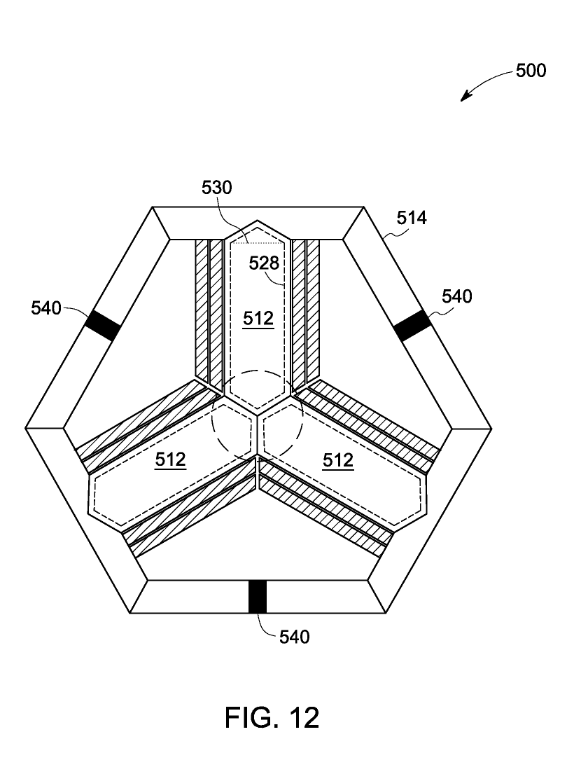

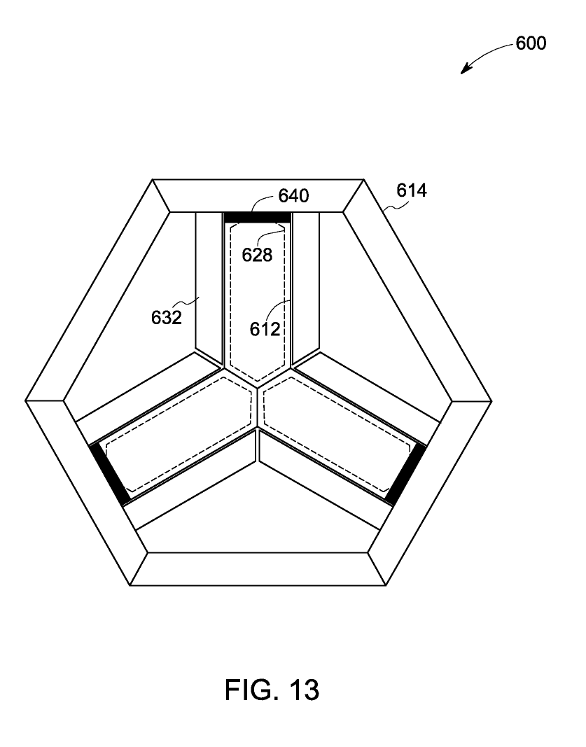

FIG. 12 is a schematic representation of a static electromagnetic device 500 comprising three gaps 540 in the yoke 514 of the static electromagnetic device 500 in accordance with an embodiment of the invention. The static electromagnetic device 500 includes three limbs 512 coupled to the yoke 514 at respective first limb ends 530. At least one of the limbs 512 or the yoke 514 comprises a duct 528 for providing the coolant in the static electromagnetic device 500. The three limbs 512 include windings 532 wound around the three limbs 512 for generating magnetic flux in the static electromagnetic device 500. The static electromagnetic device 500 comprises three gaps 540 in the yoke 514 wherein each gap 540 is provided between the first limb ends 530 of two adjacent limbs 512. The gaps 540 help the static electromagnetic device 500 to operate as an inductor/reactor.

FIG. 13 is a schematic representation of an alternative embodiment of a static electromagnetic device 600 comprising three gaps 640 between the at least three limbs 612 and the yoke 614 in accordance with an embodiment of the invention. The static electromagnetic device 600 comprises three limbs 612 coupled to each other which are enclosed by the yoke 614. At least one of the limbs 612 or the yoke 614 comprises a duct 628 for providing the coolant in the static electromagnetic device 600. The three limbs 612 include magnetic windings 632 wound around the three limbs 612 to provide the magnetic flux in the static electromagnetic device 600. The static electromagnetic device 600 further includes gaps 640 between each of the three limbs 612 and the yoke 614 which provides an inductor/reactor capability to the static electromagnetic device 600.

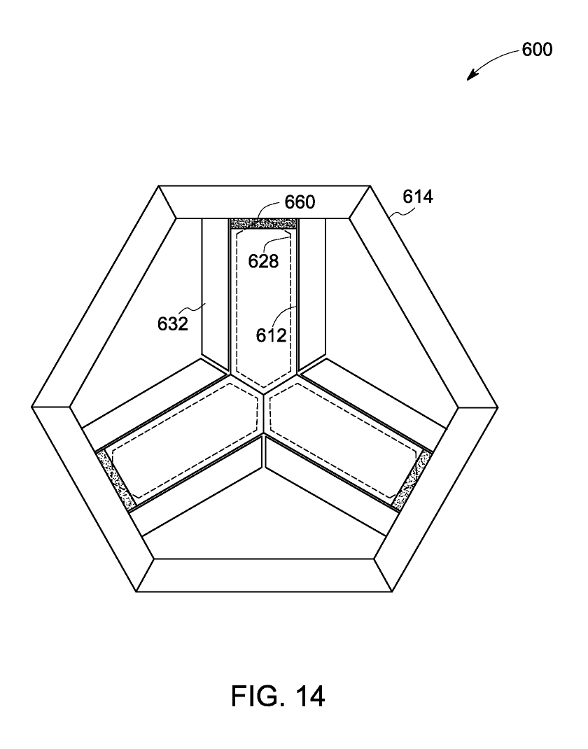

FIG. 14 is a schematic representation of another embodiment of the static electromagnetic device 600 of FIG. 13 including insulation material 660 in accordance with an embodiment of the invention. The static electromagnetic device 600 includes insulation material 660 that is disposed between each of the three limbs 612 and the yoke 614 which provides an inductor/reactor capability to the static electromagnetic device 600. In this particular embodiment, the gaps 640 of FIG. 13 are replaced by insulation material 660 which provides better inductor/reactor capability to the static electromagnetic device 600. Similarly, insulation material 660 can be provided in the yoke 614 wherein the insulation material 660 is provided between each the first limb ends of two adjacent limbs such as the gaps of FIG. 12.

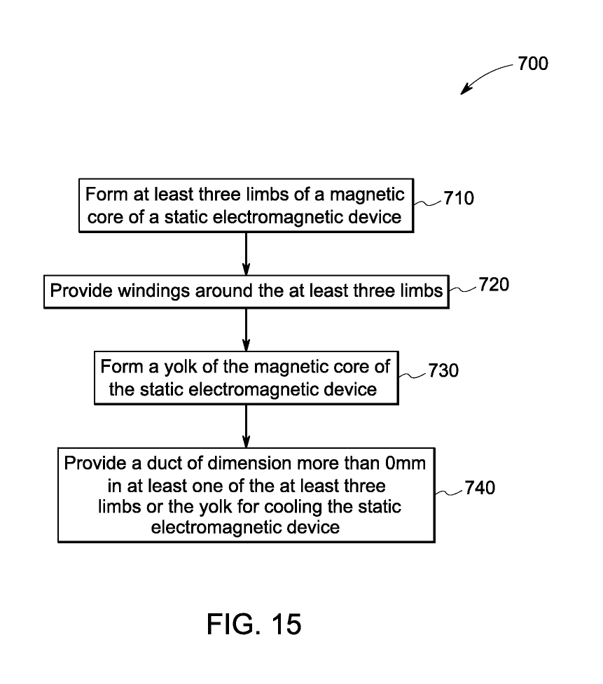

FIG. 15 is flow chart representing the steps involved in a method 700 for providing a static electromagnetic device in accordance with an embodiment of the invention. The method 700 includes forming at least three limbs of a magnetic core of a static electromagnetic device such that an angle between the at least three limbs is equal in step 710. In one embodiment, forming the at least three limbs comprises coupling the at least three limbs to each other using an overlap mitered joint. In another embodiment, forming the at least three limbs comprises coupling at least three tape wound cores to form the at least three limbs. In a specific embodiment, forming the at least three limbs comprises coupling the at least three limbs to the yoke at first limb ends wherein a distance between the first limb ends of any two adjacent limbs is equal. The method 700 also includes providing magnetic windings around the at least three limbs in step 720. In a specific embodiment, providing magnetic windings around the at least three limbs comprises providing a rectangular winding or a tapered winding. The method 700 further includes forming a yoke of the magnetic core of the static electromagnetic device in step 730. In a specific embodiment, forming the yoke comprises forming the yoke in a polyhedron structure or a concentric cylindrical structure. In a more specific embodiment, forming the yoke in the concentric cylindrical structure comprises providing an inner concentric cylindrical structure and coupling the at least three limbs to the inner concentric cylindrical structure at respective first limb ends of the at least three limbs and coupling the at least three limbs to the yoke at respective second limb ends of the at least three limbs. The method 700 also includes providing a duct in at least one of the at least three limbs or the yoke for cooling the static electromagnetic device in step 740. In one embodiment, the method 700 further includes providing at least one gap in the yoke or between the at least three limbs and the yoke. In another embodiment, the method 700 further includes providing an insulation material between each of the at least three limbs and the yoke or in the yoke between the first limb ends of two adjacent limbs.

It is to be understood that a skilled artisan will recognize the interchangeability of various features from different embodiments and that the various features described, as well as other known equivalents for each feature, may be mixed and matched by one of ordinary skill in this art to construct additional systems and techniques in accordance with principles of this disclosure. It is, therefore, to be understood that the appended claims are intended to cover all such modifications and changes as fall within the true spirit of the invention.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An electromagnetic apparatus comprising:
a static electromagnetic device comprising;
a yoke and at least three limbs comprising windings wound on a magnetic core of the static electromagnetic device,
wherein an angle between any two adjacent limbs is equal and at least one of the at least three limbs or the yoke comprises a duct.

2. The electromagnetic apparatus of claim 1, wherein the at least three limbs are coupled to each other through an overlap mitered joint.

3. The electromagnetic apparatus of claim 1, wherein the at least three limbs are formed by coupling at least three tape wound cores.

4. The electromagnetic apparatus of claim 1, wherein the at least three limbs are coupled to the yoke at first limb ends wherein a distance between the first limb ends of two adjacent limbs is equal.

5. The electromagnetic apparatus of claim 1, wherein the yoke encloses the at least three limbs.

6. The electromagnetic apparatus of claim 1, wherein the yoke comprises a polyhedron structure or a cylindrical structure.

7. The electromagnetic apparatus of claim 6, wherein the yoke comprising the cylindrical structure further comprises an inner cylindrical structure and the at least three limbs are coupled to the inner cylindrical structure at respective first limb ends and to the yoke at respective second limb ends.

8. The electromagnetic apparatus of claim 1, wherein at least one of the limbs or the yoke comprise a cruciform shape.

9. The electromagnetic apparatus of claim 1, wherein the magnetic core comprises at least one gap between each of the at least three limbs and the yoke.

10. The electromagnetic apparatus of claim 1, wherein the magnetic core comprises at least one gap in the yoke wherein the at least one gap is situated in the yoke between the first limb ends of two adjacent limbs.

11. The electromagnetic apparatus of claim 1, wherein the magnetic core comprises an insulation material between each of the at least three limbs and the yoke or in the yoke between the first limb ends of two adjacent limbs.

12. The electromagnetic apparatus of claim 1, wherein the windings comprise one of a rectangular winding and a tapered winding.

13. A method comprising:
forming at least three limbs of a magnetic core of a static electromagnetic device such that an angle between any two adjacent limbs is equal;
providing windings around the at least three limbs;
forming a yoke of the magnetic core of the static electromagnetic device; and
providing a duct in at least one of the at least three limbs or the yoke for cooling the static electromagnetic device.

14. The method of claim 13, wherein forming the at least three limbs comprises coupling the at least three limbs to each other using an overlap mitered joint.

15. The method of claim 13, wherein forming the at least three limbs comprises coupling at least three tape wound cores to form the at least three limbs.

16. The method of claim 13, wherein forming the at least three limbs comprises coupling the at least three limbs to the yoke at first limb ends wherein a distance between the first limb ends of any two adjacent limbs is equal.

17. The method of claim 13, wherein forming the yoke comprises forming the yoke in a polyhedron structure or a concentric cylindrical structure.

18. The method of claim 17, wherein forming the yoke in the concentric cylindrical structure comprises providing an inner concentric cylindrical structure and coupling the at least three limbs to the inner concentric cylindrical structure at respective first limb ends of the at least three limbs and coupling the at least three limbs to the yoke at respective second limb ends of the at least three limbs.

19. The method of claim 13, further comprising providing at least one gap in the yoke or between the at least one limb and the yoke.

20. The method of claim 13, further comprising providing an insulation material between each of the at least three limbs and the yoke or in the yoke between the first limb ends of two adjacent limbs.

21. The method of claim 13, wherein providing windings around the at least three limbs comprises providing a rectangular winding or a tapered winding.
